(19) United States
(12) Patent Application Publication
(10) Pub. No.: US 2018/0304802 A1
(43) Pub. Date: Oct. 25, 2018

(54) APPARATUS FOR TRAVELING SAFETY OF VEHICLE

(71) Applicant: Soonil CHOI, Gimpo-si (KR)

(72) Inventor: Soonil CHOI, Gimpo-si (KR)

(21) Appl. No.: 15/959,967

(22) Filed: Apr. 23, 2018

(30) Foreign Application Priority Data
Apr. 25, 2017 (KR) 10-2017-0053217

(51) Int. Cl. B60Q 1/34; B60Q 1/00; B60Q 1/46

(52) U.S. Cl. CPC B60Q 1/346; B60Q 1/343; B60Q 1/46; B60Q 1/0076

(57) ABSTRACT

Disclosed herein is an apparatus for the traveling safety of a vehicle. The apparatus includes: an emergency button configured to receive information about an emergency situation from a driver; a turn signal control lever configured to receive information about a vehicle traveling direction from the driver; and a vehicle control unit configured to, when both the emergency button and the turn signal control lever are pressed, perform mixed flickering control such that flickering of a taillight indicating a direction is performed in a manner different from a manner in which emergency flickering configured to enable both left and right taillights of the vehicle to flicker on and off is performed.

### BACKGROUND

### 1. Technical Field

The present invention relates generally to an apparatus for the traveling safety of a vehicle, and more specifically to an apparatus for the traveling safety of a vehicle, which can prevent an accident during the traveling of the vehicle.

### 2. Description of the Related Art

Turn signals used in vehicles are devices which notify the following vehicle of information about the traveling direction of a preceding vehicle and which are essential for the safety of a driver and the vehicle. The control of the turn signals may be performed by manipulating a turn signal control switch (a turn signal control lever) disposed on a side of a steering wheel in front of a driver's seat. All types of turn signal control switches for vehicles have almost the same structure.

Generally, turn signals perform the function of notifying a related vehicle of the traveling direction of a vehicle in advance or during traveling in the direction. For example, when a left turn signal is turned on, a left headlight on the front of a vehicle and a left taillight on the back of the vehicle flicker on and off. In contrast, when a right turn signal is turned on, a right headlight on the front of the vehicle and a right taillight on the back of the vehicle flicker on and off.

Meanwhile, when a vehicle is in an emergency, the taillights of the vehicle flicker on and off to warn the following vehicle, or a warning triangle is installed behind the vehicle to alert the following vehicle. Such emergency flickering is performed in such a manner that both the left and right taillights of the vehicle flicker on and off.

Meanwhile, a problem arises in that even when a turn signal is turned on during the emergency flickering of the taillights, it is not possible to provide notification of a direction intended by a driver. The reason for this is that when a driver presses an emergency button before the operation of a turn signal, the taillights are flickering on and off in an emergency flickering state, and thus it is not possible to provide notification of the operation of the turn signal.

### PRIOR ART DOCUMENT

### Patent Document

(Patent document 1) Korean Patent No. 10-0742616

### SUMMARY

An object of the present invention is to provide a means for the traveling safety of a vehicle, which can prevent an accident during the traveling of the vehicle.

According to an aspect of the present invention, there is provided an apparatus for the traveling safety of a vehicle, the apparatus including: an emergency button configured to receive information about an emergency situation from a driver; a turn signal control lever configured to receive information about a vehicle traveling direction from the driver; and a vehicle control unit configured to, when both the emergency button and the turn signal control lever are pressed, perform mixed flickering control such that flickering of a taillight indicating a direction is performed in a manner different from a manner in which emergency flickering configured to enable both left and right taillights of the vehicle to flicker on and off is performed.

The mixed flickering control may be first mixed flickering control which is performed such that emergency flickering of the left and right taillights attributable to pressing of the emergency button is stopped and only a taillight corresponding to a vehicle traveling direction input via the turn signal control lever flickers on and off;

The mixed flickering control may be second mixed flickering control which is performed such that a taillight corresponding to a vehicle traveling direction input via the turn signal control lever flickers on and off in turn signal flickering periods different from flickering periods of emergency flickering of the left and right taillights attributable to pressing of the emergency button.

The turn signal flickering periods may be shorter than the flickering periods of the emergency flickering.

The mixed flickering control may be third mixed flickering control which is performed such that a taillight corresponding to a vehicle traveling direction input via the turn signal control lever flickers on and off and the other taillight remains turned on without flickering.

The apparatus for securing traveling safety of a vehicle may further include a pressing speed sensor configured to detect a pressing speed of the turn signal control lever, and the vehicle control unit may perform one of preset first mixed flickering control, second mixed flickering control and third mixed flickering control according to the pressing speed of the turn signal control lever.

The vehicle control unit may perform the mixed flickering control in such a manner that the first mixed flickering control is selected and performed when the pressing speed of the control lever is lower than a preset first threshold value, the second mixed flickering control is selected and performed when the pressing speed of the control lever is equal to or higher than the first threshold value and lower than a preset second threshold value, and the third mixed flickering control is selected and performed when the pressing speed of the control lever is equal to or higher than the second threshold value;

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the configuration of an apparatus for the traveling safety of a vehicle according to an embodiment of the present invention;

FIG. 2 is a view showing an example of mixed flickering control according to an embodiment of the present invention;

FIG. 3 is a view showing an example of first mixed flickering control according to an embodiment of the present invention;

FIG. 4 is a view showing an example of second mixed flickering control according to an embodiment of the present invention;

FIG. 5 is a view showing an example of third mixed flickering control according to an embodiment of the present invention;

FIG. 6 is a block diagram showing the configuration of an apparatus for the traveling safety of a vehicle, which is equipped with a pressing speed sensor, according to an embodiment of the present invention; and

FIG. 7 shows examples of mixed flickering control based on pressing speed according to an embodiment of the present invention.

### DETAILED DESCRIPTION

The advantages and features of the present invention and methods for implementing the advantages and the features will be apparent from embodiments which will be described in detail with reference to the accompanying drawings. However, the present invention is not limited to the embodiments to be described below, and may be implemented in various different forms. The embodiments are provided merely to help those having ordinary knowledge in the art to which the present invention pertains to fully understand the scope of the invention. The present invention is defined only by the scopes of the attached claims. Furthermore, in the following description of the present invention, when it is determined that a detailed description of related well-known technology may make the gist of the present invention obscure, it will be omitted.

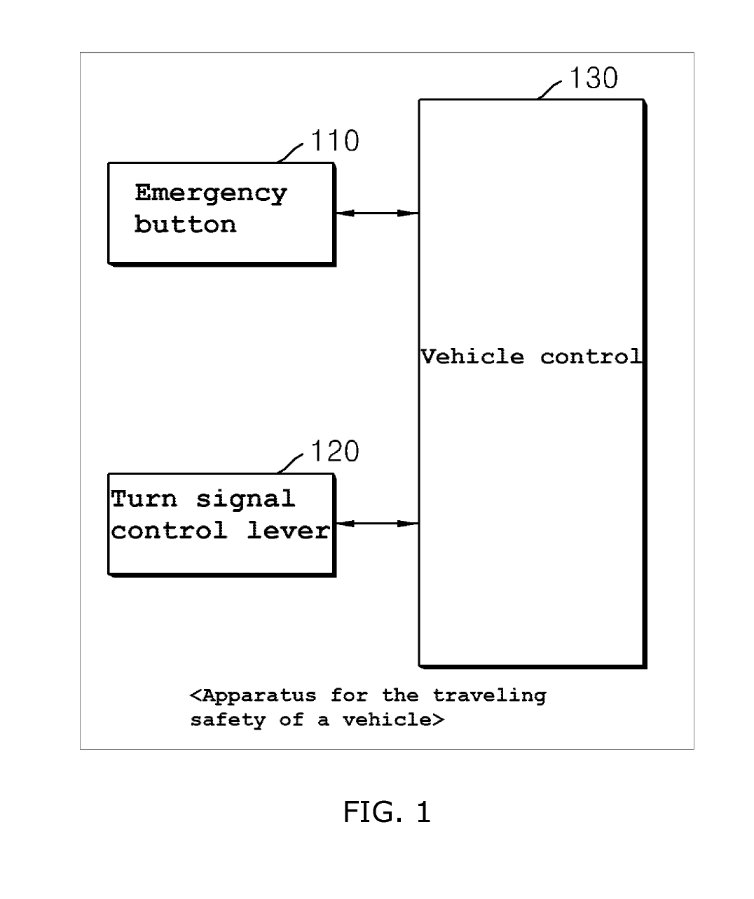

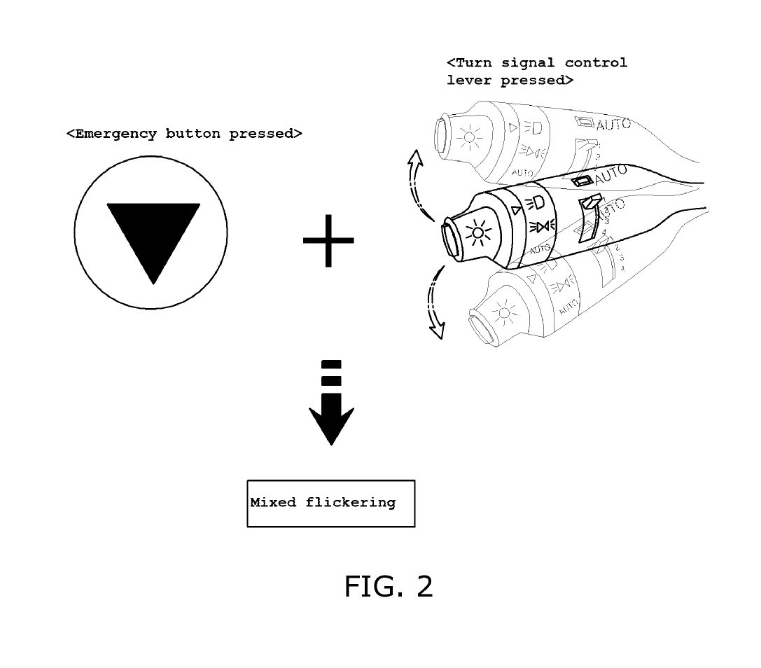

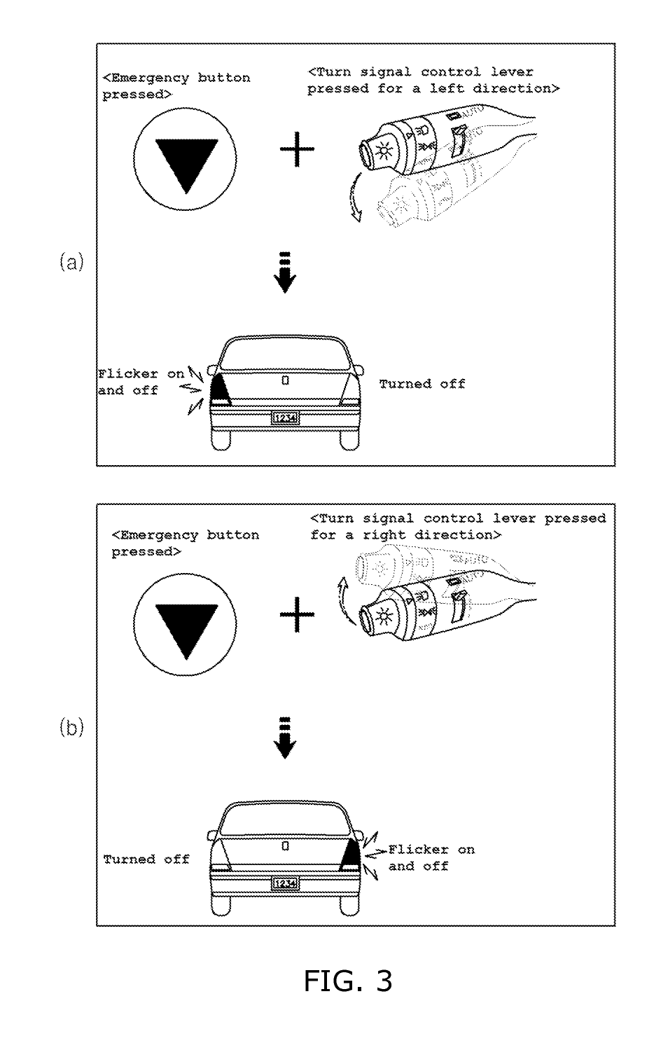

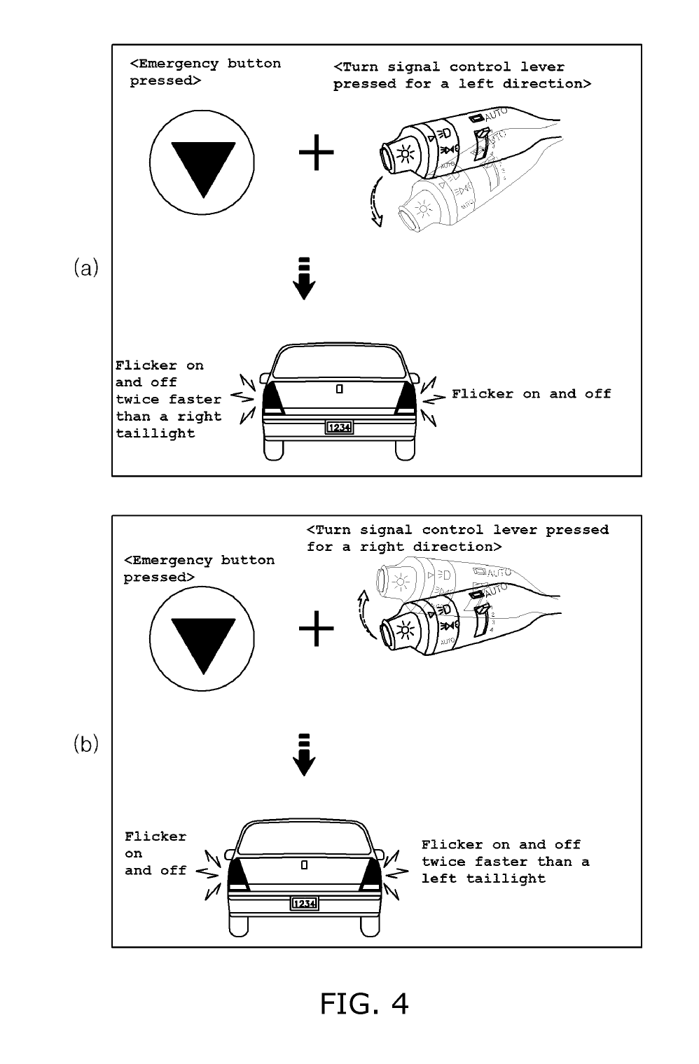

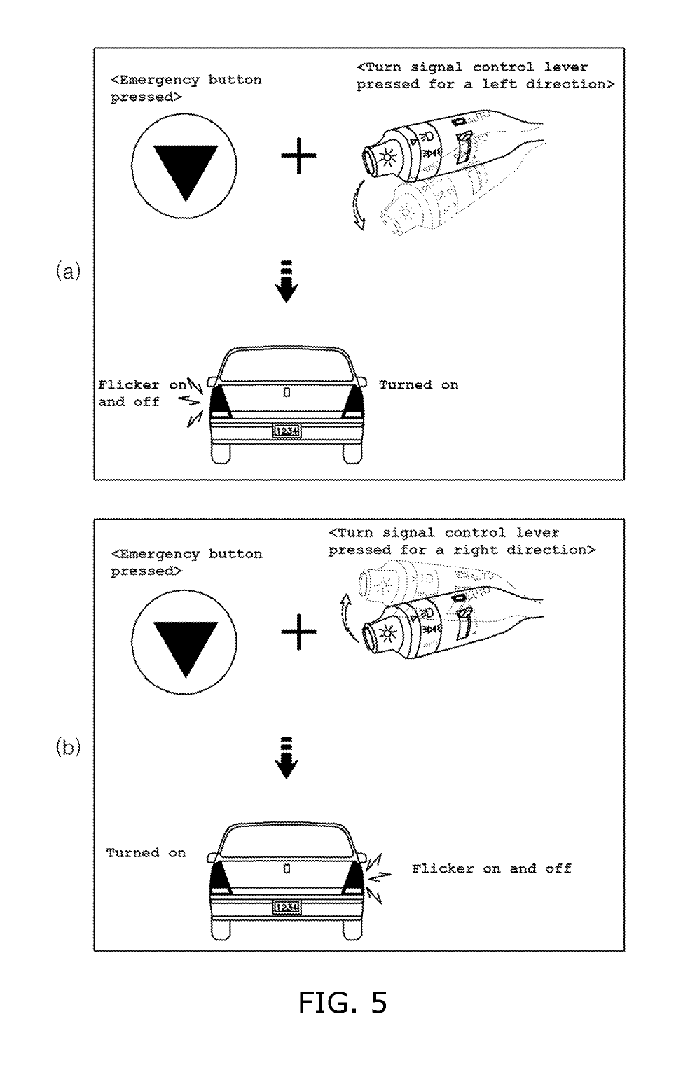

FIG. 1 is a block diagram showing the configuration of an apparatus for the traveling safety of a vehicle according to an embodiment of the present invention. FIG. 2 is a view showing an example of mixed flickering control according to an embodiment of the present invention. FIG. 3 is a view showing an example of first mixed flickering control according to an embodiment of the present invention. FIG. 4 is a view showing an example of second mixed flickering control according to an embodiment of the present invention. FIG. 5 is a view showing an example of third mixed flickering control according to an embodiment of the present invention.

As shown in FIG. 1, the apparatus for the traveling safety of a vehicle according to the present invention may include an emergency button 110, a turn signal control lever 120, and a vehicle control unit 130.

The emergency button 110 is configured to receive information about an emergency situation from a driver, and is provided within a range of adjacent distances to which a hand of the driver can reach. For example, the emergency button 110 may be provided at a location, such as the dashboard, traveling alarm instrument panel, or the like of a vehicle. Conventionally, when the emergency button 110 is pressed once, the taillights of the vehicle flicker on and off. In contrast, when the emergency button 110 is pressed twice, the flickering of the taillights of the vehicle is stopped and the taillights of the vehicle are maintained in an OFF state, i.e., a normal state.

In this case, the term “flickering” refers to a phenomenon in which a light is repeatedly and periodically turned on and off. Furthermore, the taillights of the vehicle refer to a left taillight and a right taillight which are provided on the left and right sides of the back of the vehicle, respectively. These taillights perform both a direction indication function and an emergency flickering function for an emergency.

The turn signal control lever 120 is configured to receive information about a vehicle traveling direction from a driver. The turn signal control lever 120 provided in the vehicle is a device which notifies the following vehicle of information about the traveling direction of the preceding vehicle and which is essential for the safety of the driver and the vehicle. The control of the notification of a vehicle traveling direction via the taillights may be performed by manipulating a turn signal control device (the turn signal control lever) on a side of a steering wheel in front of a driver's seat. All types of turn signal control devices for vehicles have almost the same structure.

The vehicle control unit 130 is an electronic control unit which performs the control of the driving of the vehicle and the control of the operations of other parts. In particular, when both the emergency button 110 and the turn signal control lever 120 are pressed, as shown in FIG. 2, the vehicle control unit 130 according to the present invention performs control (hereinafter referred to as “mixed flickering control”) such that the flickering of a taillight indicating a direction is performed in a manner different from the manner in which emergency flickering configured to enable both the left and right taillights of the vehicle to flicker on and off is performed.

For example, when a vehicle traveling direction is input by pressing the turn signal control lever 120 in an emergency flickering state in which both the left and right taillights are flickering on and off in response to the pressing of the emergency button 110, mixed flickering is performed such that the left and/or right taillight flicker in a form different from that of emergency flickering. When the pressing of the turn signal control lever 120 is released, the control is returned to emergency flickering such that both the left and right taillights flicker on and off.

For reference, the present invention is applied to all the cases where both the emergency button 110 and the turn signal control lever are pressed. Accordingly, mixed flickering control is performed in the case where the emergency button 110 and the turn signal control lever are pressed, in the case where the turn signal control lever is pressed after the emergency button 110 has been pressed, and in the case where the emergency button 110 is pressed after the turn signal control lever has been pressed.

Meanwhile, methods for mixed flickering control may include a first mixed flickering control method shown in FIG. 3, a second mixed flickering control method shown in FIG. 4, and a third mixed flickering control method shown in FIG. 5.

First, the first mixed flickering control method is described.

When the turn signal control lever 120 is pressed in the state in which the emergency button 110 has been pressed, first mixed flickering control is performed such that the emergency flickering of the left and right taillights attributable to the pressing of the emergency button 110 is stopped and only a taillight corresponding to a vehicle traveling direction input via the turn signal control lever 120 flickers on and off. For example, when the turn signal control lever 120 is pressed to indicate a left direction in the state in which the emergency button has been pressed, as shown in FIG. 3(a), only the left taillight is made to flicker on and off, and the right taillight is turned off. In contrast, the turn signal control lever 120 is pressed to indicate a right direction in the state in which the emergency button has been pressed, as shown in FIG. 3(b), only the right taillight is made to flicker on and off, and the left taillight is turned off.

The second mixed flickering control method is performed such that when the turn signal control lever 120 is pressed, a taillight corresponding to a vehicle traveling direction input via the turn signal control lever 120 flickers on and off in turn signal flickering periods different from the flickering periods of the emergency flickering of the left and right taillights attributable to the pressing of the emergency button. In this case, the turn signal flickering periods may be shorter than the flickering periods of the emergency flickering. For example, when the turn signal control lever 120 is pressed to indicate a left direction in the state in which the emergency button has been pressed, as shown in FIG. 4(a), the left taillight flickers on and off in flickering periods twice shorter than the flickering periods of the right taillight. In contrast, when the turn signal control lever 120 is pressed to indicate a right direction in the state in which the emergency button has been pressed, as shown in FIG. 4(b), the right taillight flickers on and off in flickering periods twice shorter than the flickering periods of the left taillight.

The third mixed flickering control method is performed such that when the turn signal control lever 120 is pressed, a taillight corresponding to a vehicle traveling direction input via the turn signal control lever 120 flickers on and off and the other taillight remains turned on without flickering. For example, when the turn signal control lever 120 is pressed to indicate a left direction in the state in which the emergency button has been pressed, as shown in FIG. 5(a), the left taillight flickers on and off, and the right taillight remains turned on without flickering. In contrast, when the turn signal control lever 120 is pressed to indicate a right direction in the state in which the emergency button has been pressed, as shown in FIG. 5(b), the right taillight flickers on and off, and the left taillight remains turn on.

Furthermore, in addition to the above-described mixed flickering control method, other various examples may be implemented. For example, an implementation may be made such that upon sudden braking, an emergency light operation mode is automatically entered and thus the taillights perform emergency flickering.

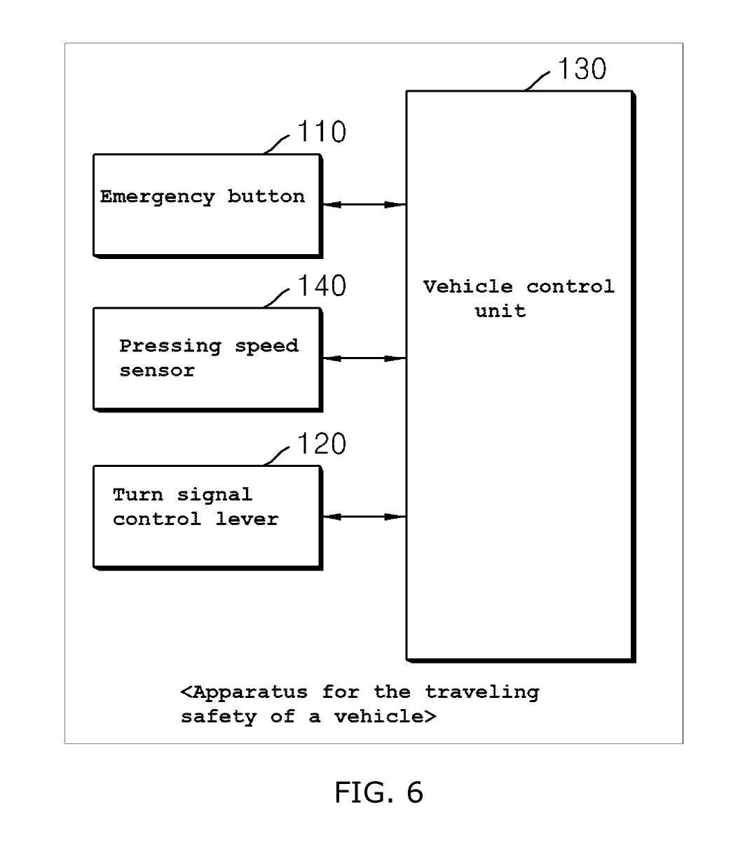

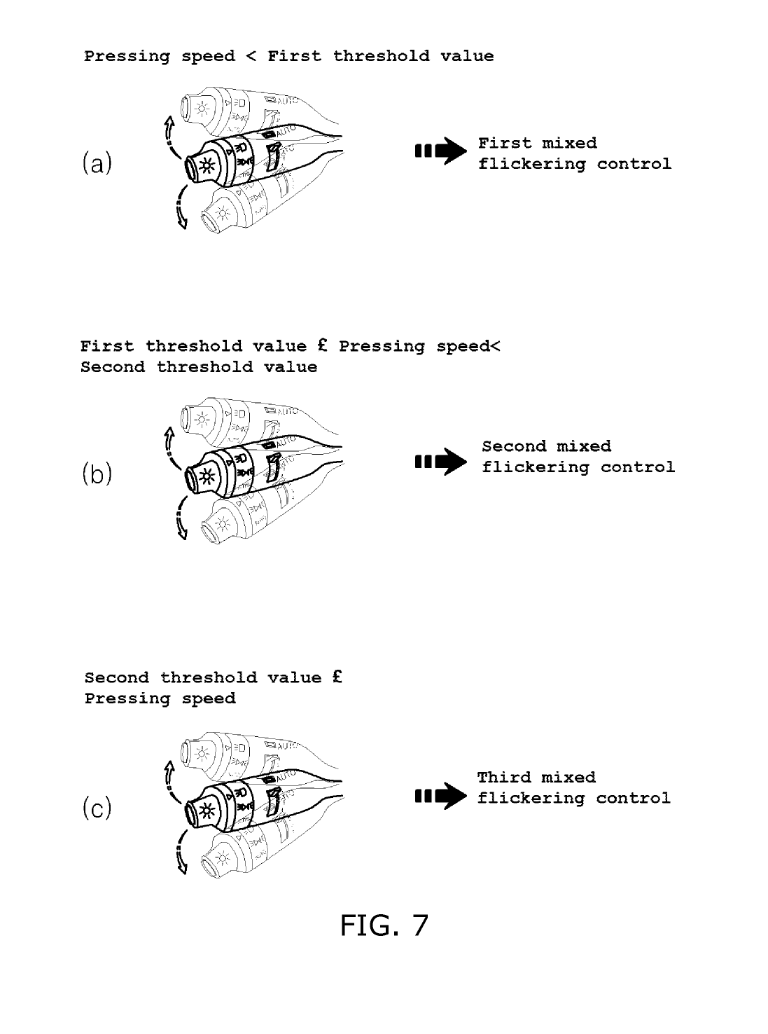

Meanwhile, an implementation may be made such that one of first mixed flickering control, second mixed flickering control, and third mixed flickering control is selected and performed according to the pressing speed of the turn signal control lever. This will be described below with reference to FIGS. 6 and 7.

FIG. 6 is a block diagram showing the configuration of an apparatus for the traveling safety of a vehicle, which is equipped with a pressing speed sensor, according to an embodiment of the present invention, and FIG. 7 shows examples of mixed flickering control based on pressing speed according to an embodiment of the present invention.

As shown in FIG. 6, the apparatus for the traveling safety of a vehicle may include a pressing speed sensor 140 in addition to an emergency button 110, a turn signal control lever 120, and a vehicle control unit 130.

The pressing speed sensor 140 is configured to detect the pressing speed of the turn signal control lever 120. Accordingly, when a driver presses the turn signal control lever 120 fast, a high pressing speed will be detected. In contrast, when a driver presses the turn signal control lever 120 slow, a low pressing speed will be detected.

The vehicle control unit 130 is implemented to perform one of preset first mixed flickering control, second mixed flickering control, and third mixed flickering control according to the pressing speed of the turn signal control lever.

The selection of a mixed flickering control method according to pressing speed may be performed by selecting one of two control methods based on a single threshold value. For example, when the pressing speed of the control lever is lower than a preset reference threshold value, the first mixed flickering control may be selected and performed. In contrast, when the pressing speed of the control lever is equal to or higher than the reference threshold value, the second mixed flickering control may be selected and performed. Alternatively, when the pressing speed of the control lever is lower than a preset reference threshold value, the first mixed flickering control may be selected and performed. In contrast, when the pressing speed of the control lever is equal to or higher than the reference threshold value, the third mixed flickering control may be selected and performed.

Furthermore, as another embodiment, the selection of a mixed flickering control method according to pressing speed may be performed by selecting one from among three control methods based on two threshold values. For example, when the pressing speed of the control lever is lower than a preset first threshold value, as shown in FIG. 7, first mixed flickering control may be selected and performed. When the pressing speed of the control lever is equal to or higher than the first threshold value and lower than a preset second threshold value, as shown in FIG. 7(b), second mixed flickering control may be selected and performed. In contrast, when the pressing speed of the control lever is equal to or higher than the second threshold value, as shown in FIG. 7(c), third mixed flickering control may be selected and performed.

There may be various embodiments configured to select a mixed flickering method based on pressing speed as described above.

According to an embodiment of the present invention, when emergency lights flicker on and off and simultaneously a turn signal is operated, the following vehicle can be notified of a traveling direction, and thus the safety of vehicle traveling can be secured.

The above-described embodiments are provided to help those skilled in the art understand the present invention. The technical spirit of the present invention is not restricted and limited only to the embodiments. Various modifications and alterations and other equivalent embodiments may be made without departing from the technical spirit of the present invention.

What is claimed is:

1. An apparatus for traveling safety of a vehicle, the apparatus comprising:
an emergency button configured to receive information about an emergency situation from a driver;
a turn signal control lever configured to receive information about a vehicle traveling direction from the driver;
a vehicle control unit configured to, when both the emergency button and the turn signal control lever are pressed, perform mixed flickering control such that flickering of a taillight indicating a direction is performed in a manner different from a manner in which emergency flickering configured to enable both left and right taillights of the vehicle to flicker on and off is performed; and
a pressing speed sensor configured to detect a pressing speed of the turn signal control lever;
wherein the vehicle control unit performs one of preset first mixed flickering control, second mixed flickering control and third mixed flickering control according to the pressing speed of the turn signal control lever in such a manner that the first mixed flickering control is selected and performed when the pressing speed of the control lever is lower than a preset first threshold value, the second mixed flickering control is selected and performed when the pressing speed of the control lever is equal to or higher than the first threshold value and lower than a preset second threshold value, and the third mixed flickering control is selected and performed when the pressing speed of the control lever is equal to or higher than the second threshold value;
wherein the first mixed flickering control is performed such that emergency flickering of the left and right taillights attributable to pressing of the emergency button is stopped and only a taillight corresponding to a vehicle traveling direction input via the turn signal control lever flickers on and off;
wherein the second mixed flickering control is performed such that a taillight corresponding to a vehicle traveling direction input via the turn signal control lever flickers on and off in turn signal flickering periods different from flickering periods of emergency flickering of the left and right taillights attributable to pressing of the emergency button and the turn signal flickering periods are shorter than the flickering periods of the emergency flickering; and
wherein the third mixed flickering control is performed such that a taillight corresponding to a vehicle traveling direction input via the turn signal control lever flickers on and off and the other taillight remains turned on without flickering.
